(19) United States
(12) Patent Application Publication
(10) Pub. No.: US 2006/0173649 A1
(43) Pub. Date: Aug. 3, 2006

(54) Active speed detecting device for vehicle

(76) Inventor: Shih-Hsiung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/045,258

(22) Filed: Jan. 31, 2005

(51) Int. Cl. G01P 3/00

(52) U.S. Cl. 702/145

(57) ABSTRACT

A speed detecting device includes a rotating member and a sensor. The rotating member is coupled to a rotating portion of a vehicle to turn therewith. The rotating member includes at least one object formed thereon. The at least one object is made of non-magnet metal. The sensor is connected to an active signal line. The senor is not empowered by an external power source. A magnetic field is created and electric current is generated when the rotating member rotates, generating signals regarding rotational speed of the rotating portion.

### BACKGROUND OF THE INVENTION

1. Field of the Invention

The present invention relates to a speed detecting device. In particular, the present invention relates to a speed detecting device for a vehicle.

2. Description of the Related Art

A typical speedometer is of mechanical type and is connected by a speed transmission member or rotating cable to a rotating shaft to which the front wheels of a vehicle are mounted. The speed transmission member is liable to be worn out by moisture and mud. Further, vibrations of the vehicle causes friction and wear to the rotating cable and the rotating shaft in addition to high friction as a nature of mechanical transmission. Further, the rotating cable is apt to coil in an undesired manner, failing to provide the required transmission function. Further, the speed transmission member or rotating cable consumes power and fuel and could not provide reliable information of the speed of the vehicle.

Hall elements have been proposed to detect the speed of a vehicle. A typical Hall element comprises a sensor. A magnet (usually a permanent magnet) is attached to a rotating member of a vehicle and is sensed by the sensor when the magnet comes to a position adjacent to the sensor. A signal is generated based on a change in the magnetic flux and converted into a signal relating to speed, which is then displayed by digit. Thus, the speed of the vehicle can be detected upon rotation of the rotating member (such as the front wheel shaft or a wheel of the vehicle) without physical contact of the Hall element. However, the cost of the magnet is high. Further, the magnetic field for the detection purposes must be created by external electric current for providing transmission of signals. Thus, the speed signals cannot be transmitted when the vehicle could not provide power required for generating the electric current.

### SUMMARY OF THE INVENTION

An objective of the present invention is to provide an active speed detecting device including a sensor that provides active signal transmission.

Another objective of the present invention is to provide an active speed detecting device that can be operated without using a magnet.

In accordance with the present invention, a speed detecting device comprises a rotating member and a sensor. The rotating member is coupled to a rotating portion of a vehicle to turn therewith. The rotating member includes at least one object formed thereon. The at least one object is made of non-magnet metal. The sensor is connected to an active signal line. The senor is not empowered by an external power source. A magnetic field is created and electric current is generated when the rotating member rotates, generating signals regarding rotational speed of the rotating portion.

The sensor may include a metal rod and a coil wound around the metal rod. Alternatively, the sensor includes a Hall element.

In an embodiment of the invention, the at least one object includes a plurality of protrusions annularly spaced on a side of the rotating member, and the sensor includes an end face spaced from the protrusions along a direction parallel to the axis about which the rotating member turns.

In another embodiment of the invention, the at least one object includes a plurality of recessed portions annularly spaced on a side of the rotating member, and the sensor includes an end face spaced from the protrusions along a direction parallel to the axis about which the rotating member turns.

In a further embodiment of the invention, the at least one object includes a plurality of annularly spaced projections projecting radially outward from an outer periphery of the rotating member, and the sensor includes an end face spaced from the projections along a direction parallel to the axis about which the rotating member turns.

In still another embodiment of the invention, the at least one object includes a plurality of annularly spaced walls projecting outward from a peripheral edge of the rotating member along a direction parallel to the axis about which the rotating member turns, and the senor includes an end face spaced from the along a direction orthogonal to the axis about which the rotating member turns.

In yet another embodiment of the invention, the at least one object includes a plurality of annularly spaced. protrusions on an outer periphery of the rotating member, and the sensor includes an end face spaced from the protrusions along a direction orthogonal to an axis about which the rotating member turns.

In still another embodiment of the invention, the at least one object includes a plurality of annularly spaced protrusions on an outer periphery of the rotating member, and the sensor includes a lateral side spaced from the protrusions along a direction orthogonal to an axis about which the rotating member turns.

The rotating portion of the vehicle may be a rotating cable or an engine transmission cable.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of a first embodiment of an active speed detecting device in accordance with the present invention.

FIG. 2 is an exploded perspective view of the active speed detecting device in FIG. 1

FIG. 3 is a side elevational view of the active speed detecting device in FIG. 1.

FIG. 4 is an exploded perspective view of the active speed detecting device in FIG. 1, a speedometer, and a rotating portion to be detected.

FIG. 5 is a perspective view of a second embodiment of the active speed detecting device in accordance with the present invention.

FIG. 6 is a perspective view of a third embodiment of the active speed detecting device in accordance with the present invention.

FIG. 7 is a perspective view of a fourth embodiment of the active speed detecting device in accordance with the present invention.

FIG. 8 is a perspective view of a fifth embodiment of the active speed detecting device in accordance with the present invention.

FIG. 9 is a perspective view of a sixth embodiment of the active speed detecting device in accordance with the present invention.

### DETAILED DESCRIPTION OF THE PREFERRED EMBODIMENTS

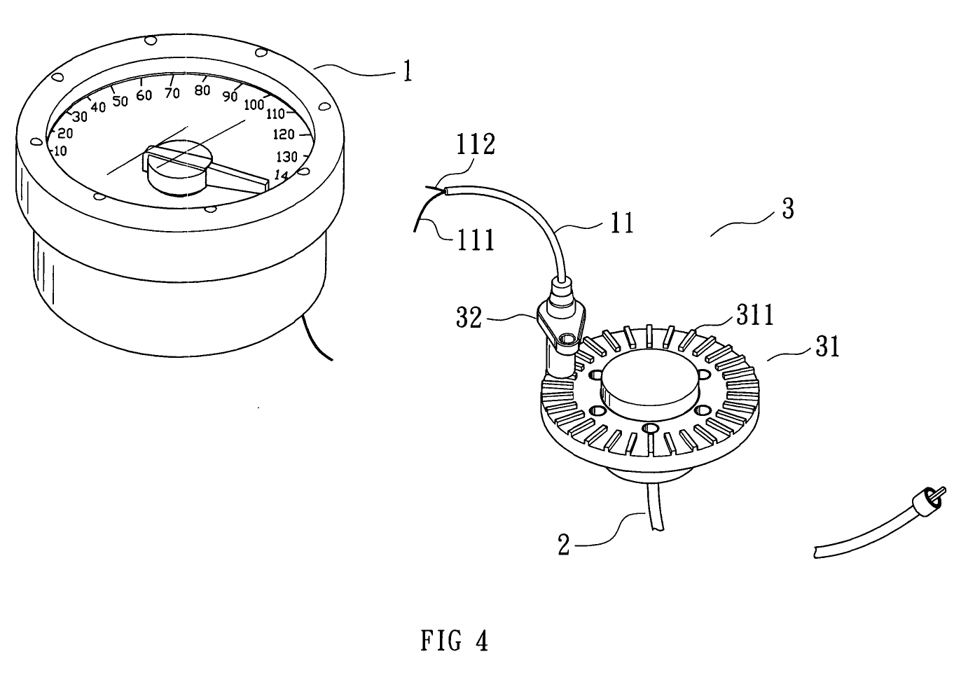

Referring to FIG. 4, an active speed detecting device 3 in accordance with the present invention is used to detect rotational speed of a rotating portion 2 of a vehicle and comprises a first end coupled to the rotating portion 2 of the vehicle and a second end coupled to a speedometer 1. The rotating portion 2 is a portion of a vehicle, such as the engine, wheels, or any rotating element or member of the vehicle. In the illustrated embodiment, the rotating portion 2 is a rotating cable or an engine transmission cable that rotates in proportion to the speed of the portion of the vehicle to be detected.

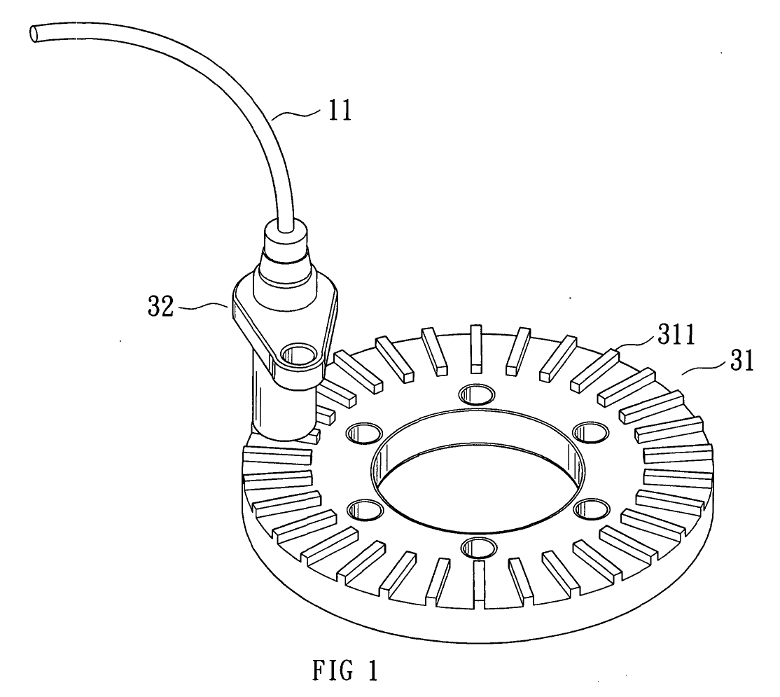

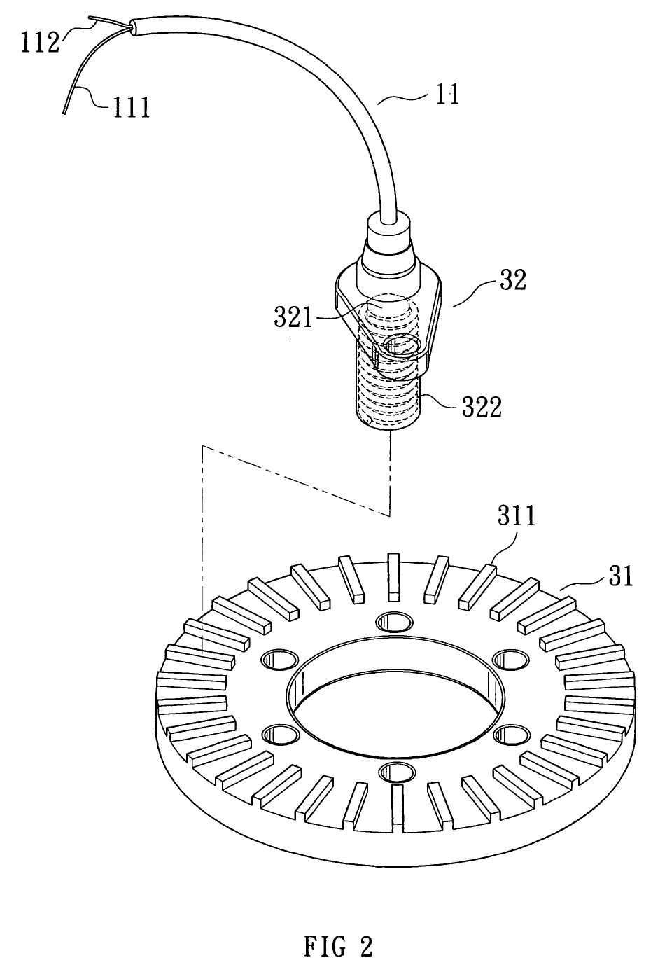

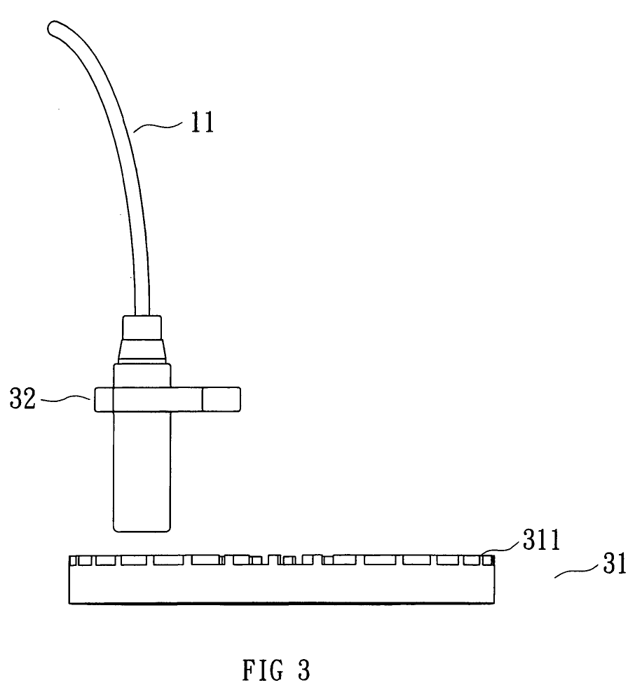

In the embodiment illustrated in FIGS. 1 through 4, the speed detecting device 3 comprises a rotating member 31 connected to the rotating portion 2 of the vehicle to turn therewith. The rotating member 31 is a disc including at least one object 31 on a side of the disc. In the illustrated embodiment, a plurality of objects 31 are annularly spaced on a side of the rotating member 31 and project outward from the side of the rotating member 31. The objects or protrusions 31 are made of non-magnet metal.

The speed detecting device 3 further comprises a sensor 32. The sensor 32 includes a metal rod 321 and a coil 322 wound around the metal rod 321. Alternatively, the sensor 32 includes a Hall element. The sensor 32 is coupled to the speedometer 1 via an active signal line 111 and a grounding wire 112 that are enclosed in a sheath 11. It is noted that the sensor 32 is not connected to any external power source. Namely, the sensor 32 is not empowered by any external power source.

The sensor 32 is located adjacent to the objects 311 and has an end face facing the objects 311. When the rotating member 31 rotate, a magnetic field is created due to magnetic induction, generating signals regarding rotational speed of the rotating member 31 that is coupled to the rotating portion 2 to turn therewith. The signals regarding rotational speed of the rotating member 31 are based on the number of the objects 311 passing through the sensor 32 in a time unit. The electric current generated during magnetic induction is used to send the signals regarding rotational speed of the rotating member 31 (i.e., regarding the rotating portion 2 to be detected) to the speedometer 1. The speed of the rotating portion 2 is displayed by a digital or analogous display after operation by the electric elements of the speedometer 1.

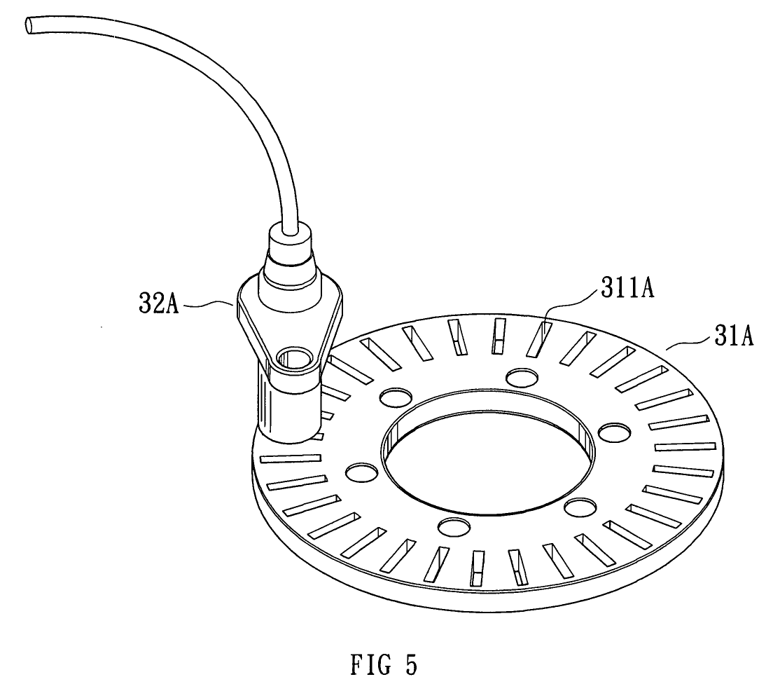

FIG. 5 shows a second embodiment of the invention, wherein the objects are annularly spaced recessed portions 311A in the side of the rotating member 31A, and an end face of the sensor 32A is spaced from the recessed portions 311A along a direction parallel to an axis about which the rotating member 31A turns.

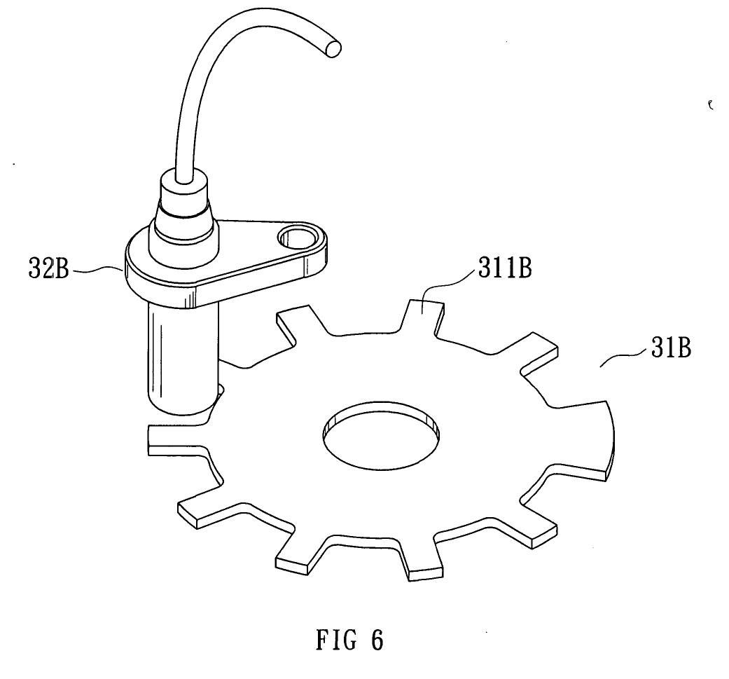

FIG. 6 shows a third embodiment of the invention, wherein the objects are annularly spaced projections 311B projecting radially outward from an outer periphery of the rotating member 31B, and an end face of the sensor 32B is spaced from the projections 311B along a direction parallel to the axis about which the rotating member 31B turns.

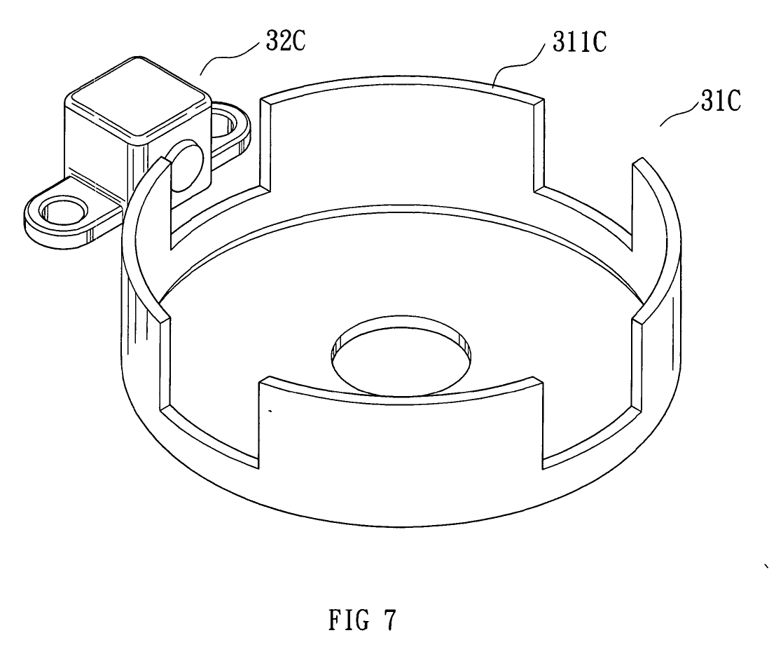

FIG. 7 shows a fourth embodiment of the invention, wherein the objects are annularly spaced walls 311C projecting outward from a peripheral edge of the rotating member 31C along a direction parallel to the axial direction of the rotating member 31C about which the rotating member 31C turns, and an end face of the sensor 32C is spaced from the walls 311C along a direction orthogonal to the axis about which the rotating member 31C turns.

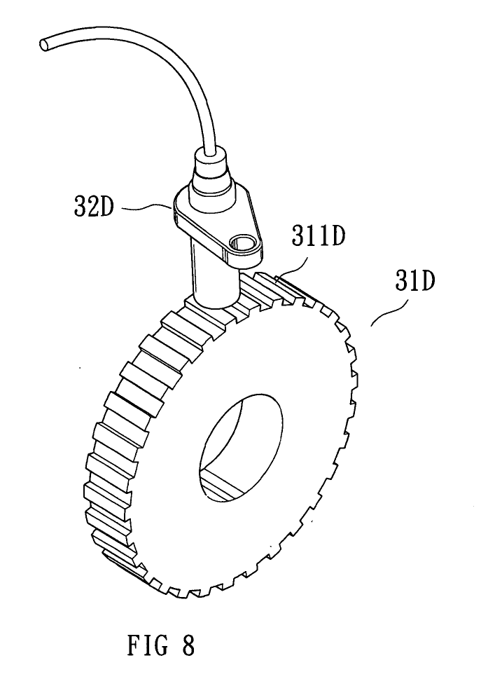

FIG. 8 shows a fifth embodiment of the invention, wherein the objects are annularly spaced protrusions 311D on an outer periphery of the rotating member 31D, and an end face of the sensor 32D is spaced from the protrusions 311D along a direction orthogonal to the axis about which the rotating member 31D turns.

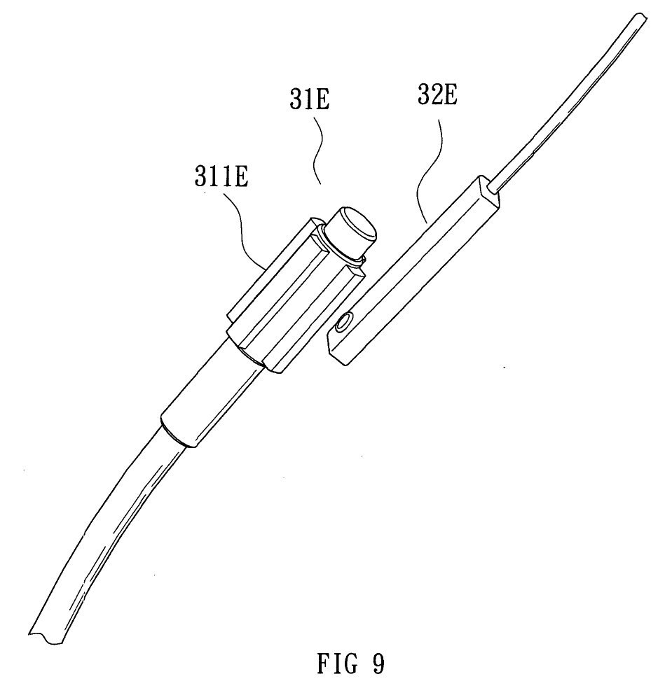

FIG. 9 shows a sixth embodiment of the invention, wherein the objects are annularly spaced protrusions 311E on an outer periphery of the rotating member 31E, and a lateral side of the sensor 32E is spaced from the protrusions 311E along a direction orthogonal to the axis about which the rotating member 31E turns.

The non-contact type sensing system in accordance with the present invention provides reliable indication of the speed of the rotating portion of a vehicle to be detected. Friction resulting from mechanical transmission in conventional designs for detecting the speed of the vehicle is avoided. Wear to the rotating cable is avoided. The output power of the vehicle is not sacrificed and the fuel consumption is lowered. The structure and mounting of the active speed detecting device are simple, leading to a reduction in the cost, which is advantageous to mass production. Further, the active speed detecting device is waterproof and more reliable. No external power is required for the sensor 32, 32A, 32B, 32C, 32D, 32E. Further, non-magnet metal such as iron core can be used as the senor 32, 32A, 32B, 32C, 32D, 32E, which is more economic.

Although specific embodiments have been illustrated and described, numerous modifications and variations are still possible without departing from the essence of the invention. The scope of the invention is limited by the accompanying claims.

What is claimed is:

1. A speed detecting device comprising:
a rotating member adapted to be coupled to a rotating portion of a vehicle to turn therewith, the rotating member including at least one object formed thereon, said at least one object being made of non-magnet metal; and
a sensor adapted to be connected to an active signal line, the senor being not empowered by an external power source;
wherein a magnetic field is created and electric current is generated when the rotating member rotates, generating signals regarding rotational speed of the rotating portion.

2. The speed detecting device as claimed in claim 1, wherein the sensor includes a metal rod and a coil wound around the metal rod.

3. The speed detecting device as claimed in claim 1, wherein the sensor includes a Hall element.

4. The speed detecting device as claimed in claim 1, wherein said at least one object includes a plurality of protrusions annularly spaced on a side of the rotating member, and wherein the sensor includes an end face spaced from the protrusions along a direction parallel to an axis about which the rotating member turns.

5. The speed detecting device as claimed in claim 1, wherein said at least one object includes a plurality of recessed portions annularly spaced on a side of the rotating member, and wherein the sensor includes an end face spaced from the protrusions along a direction parallel to an axis about which the rotating member turns.

6. The speed detecting device as claimed in claim 1, wherein said at least one object includes a plurality of annularly spaced projections projecting radially outward from an outer periphery of the rotating member, and wherein the sensor includes an end face spaced from the projections along a direction parallel to an axis about which the rotating member turns.

7. The speed detecting device as claimed in claim 1, wherein said at least one object includes a plurality of annularly spaced walls projecting outward from a peripheral edge of the rotating member along a direction parallel to an axis about which the rotating member turns, and wherein the senor includes an end face spaced from the along a direction orthogonal to an axis about which the rotating member turns.

8. The speed detecting device as claimed in claim 1, wherein said at least one object includes a plurality of annularly spaced protrusions on an outer periphery of the rotating member, and wherein the sensor includes an end face spaced from the protrusions along a direction orthogonal to an axis about which the rotating member turns.

9. The speed detecting device as claimed in claim 1, wherein said at least one object includes a plurality of annularly spaced protrusions on an outer periphery of the rotating member, and wherein the sensor includes a lateral side spaced from the protrusions along a direction orthogonal to an axis about which the rotating member turns.

10. The speed detecting device as claimed in claim 1, wherein the rotating portion of the vehicle is a rotating cable.

11. The speed detecting device as claimed in claim 1, wherein the rotating portion of the vehicle is an engine transmission cable.
